(19) United States
(12) Patent Application Publication
(10) Pub. No.: US 2006/0239768 A1
(43) Pub. Date: Oct. 26, 2006

(54) Lock device in an articulated joint for a foldable ladder

(76) Inventor: Chin-Wen Yeh, Keelung (TW)

Correspondence Address: G. LINK CO. LTD., 3550 Bell Road, Minooka, IL, 60447, US

(21) Appl. No.: 11/111,593

(22) Filed: Apr. 22, 2005

(51) Int. Cl. F16C 11/00

(52) U.S. Cl. 403/92

(57) ABSTRACT

An articulated joint for a foldable ladder includes an outer casing pair, an inner casing pair pivotally moving with respect to the outer casing pair, a lock device composed of a lock block and a locating pin and a trigger for pressing the lock block apart from the locating recesses at the inner pair. The locating pin has a ball end and the lock block has a locating hole at a side thereof corresponding to the ball end for the ball end fitting with the locating hole to allow the lock block integrally joined to the locating pin as a single piece. The lock block provides the side joining with the locating pin with projections at two opposite edges thereof for preventing the lock block, the locating pin and the spring from loosening apart.

### FIELD OF THE INVENTION

The present invention relates to a lock device in an articulated joint for a foldable ladder and particularly to a lock device, which is capable of keeping the parts off loosening, for securing safety of the articulated joint while in use.

### BACKGROUND OF THE INVENTION

Referring to FIG. 1, an articulated joint with a conventional lock device includes an outer casing pair 10, an inner casing pair 20, a lock block set 30, a spring 40, a trigger 50, a slidable element 70, a casing secure rivet 80 and a trigger locating rivet 90. The outer casing pair 10 is composed of two opposite outer casing shells 11, 12 and each of the outer casing shells 11, 12 has a circular upper section and an elongated lower section with a guide slot 13 at the intersection of the circular section and the elongated section and being disposed along radial direction of the circular section. A trigger locating hole 16 beside the sliding slot 13 near a lateral side of the respective outer casing shell 11, 12 for rotationally locating the trigger 50 with the trigger locating rivet 90. A secure hole 19 is provided at the bottom area of the lower section of the two outer casing shells 11, 12 for being fixedly attached to one of the rails on a ladder. Besides, the outer casing shell 12 has a spring seat 14 and the spring seat 14 is disposed below the guide slot 13 at the outer casing shell 12 with a pinhole 141 for locating the lock block set 300. The lock block set 300 includes a lock block 310, a fixing plate 350 and a locating pin 320. The lock block 310 has a blind hole at an elongated side thereof and the fixing plate 350 basically is a short U shaped sheet with a central through hole and two opposite extending outward lateral sides. The lock block 310 sits on the fixing plate 350 with the side having the blind hole aligning with the through hole of the fixing plate 350 and an end of the locating pin 32 enters the blind hole via the through hole and the pinhole 141 being passed through by another end of the locating pin 32. A spring 40 surrounds the locating pin 32 with en end of the spring touching the spring seat 14 and another end of the spring 14 touching the lower side of the lock block 31. The inner casing pair 20 is composed of two opposite inner casing shells 21, 22. Each of the inner casing shells 21, 22 has an upper circular section and an elongated lower section too and provides three locating recesses 231, 232, 233 for catching the lock block 310. Further, each of the inner casing shells 21, 22 has three arc slots 24 for receiving three short pins 60 attached to the slidable element 700 and allowing the short pins 60 with the slidable element 700 moving along the arc slots 24. Further, the inner casing shell 22 has a locating tongue 25 at the lower part of the circular section thereof for locating an end of an extension spring 71, which has the other end thereof being attached to an end of the slidable element 70. The inner casing shells 21, 22 provide fixing holes 29 for being fixedly attached to a rail of another ladder part of the foldable ladder with rivets. In addition, the trigger 50 has the upper part contacting the lock block 30 and the top edge thereof pressing against the slidable element 70 at the lowermost short pins. The inner casing pair 20 and the outer casing pair 10 are rotationally joined together. Once the outer casing shells 11, 12 are joined to each other, a space is constituted between the upper circular sections of the outer casing shells 11, 12 for positioning the inner casing pair 20. While the trigger 50 is pressed to move the lock block 31 out of one of the locating recesses 231, 232, 233 and an angle between the outer casing pair 10 and the inner casing pair 20 can adjusted till the lock block 31 enter another one of the locating recesses 231, 232, 233.

As the foregoing, the lock device, which is composed of the lock block 310, the fixing plate 350, the locating pin 320 and the spring 400, is detachable such that it is easy for the parts of the lock device become loosening apart from each other during the foldable ladder being in use. As a result, it is very likely to occur unexpected danger.

### SUMMARY OF THE INVENTION

An object of the present invention is to provide a lock device in an articulated joint for a foldable ladder in which the lock block is integrally joined to a ball end of the locating pin and the lock block at the side joining with the locating pin provides a plurality of projections at two opposite long edges thereof so as to prevent the parts of the lock device from loosening and secure steadiness of the articulated joint for enhancing safety during the ladder being in use.

Another object of the present invention is to provide a lock device in an articulated joint for a foldable ladder in which simply and rapidly assembled parts are provided for easing fabrication job of the articulated joint.

### BRIEF DESCRIPTION OF THE DRAWINGS

The present invention can be more fully understood by reference to the following description and accompanying drawings, in which:

FIG. 1 is an exploded perspective view of an articulated joint illustrating the conventional lock device;

FIG. 2 is an exploded perspective view of an articulated joint illustrating a lock device according to the present invention;

FIG. 3 is an exploded perspective view of the lock device 30 in FIG. 2;

FIG. 4 is a perspective view illustrating the lock device 30 being assembled with riveting and stamped projections on the secure block thereof;

FIG. 5 is a plan view illustrating locations of the projections on the secure block; and

FIG. 6 is a perspective view illustrating another embodiment of the lock device according to the present invention.

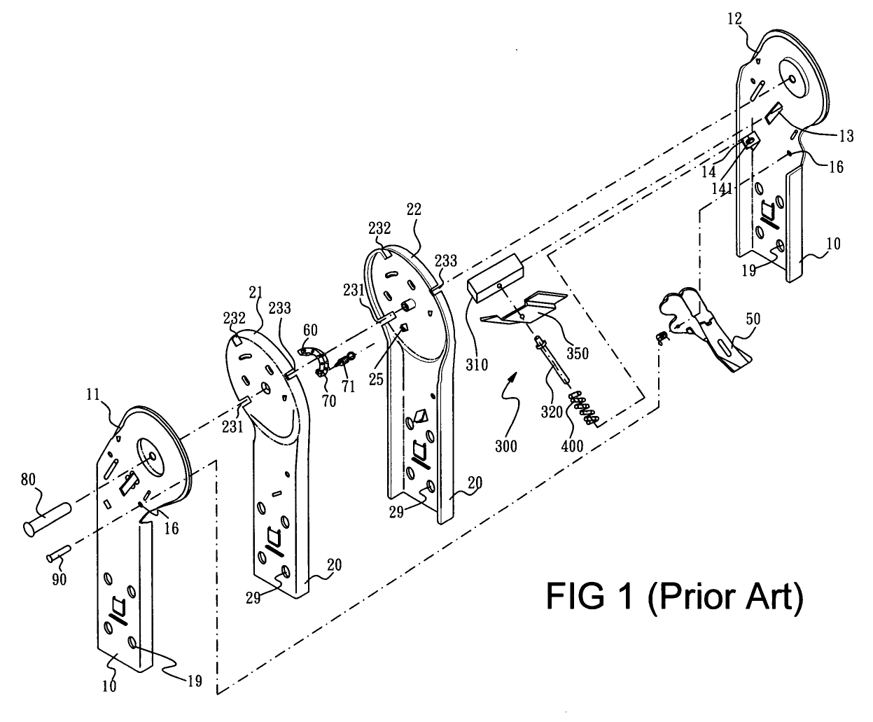

### DETAILED DESCRIPTION OF THE INVENTION

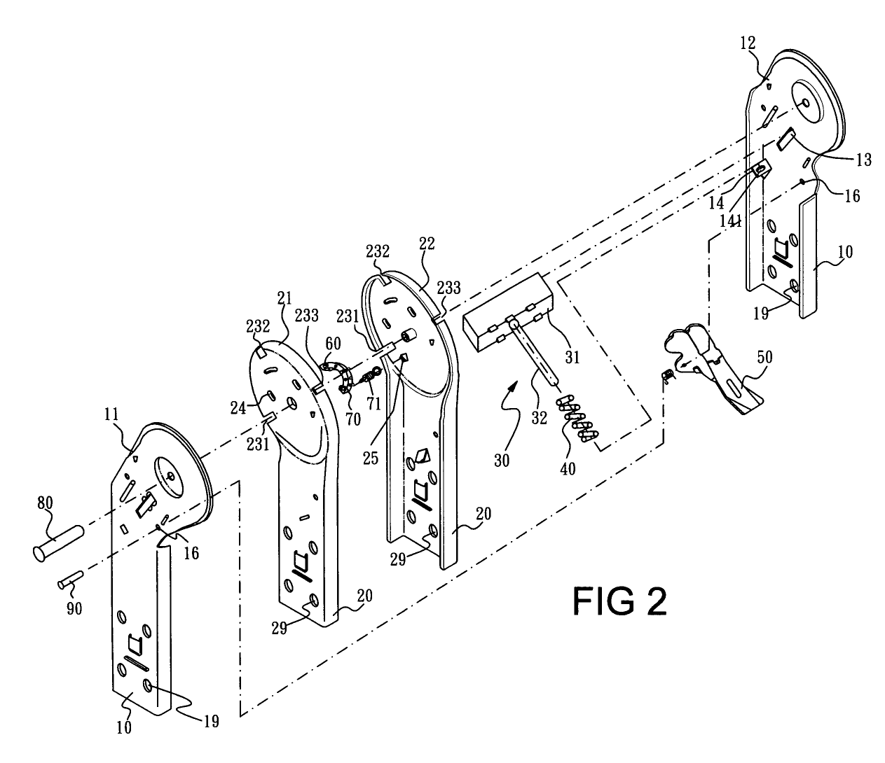

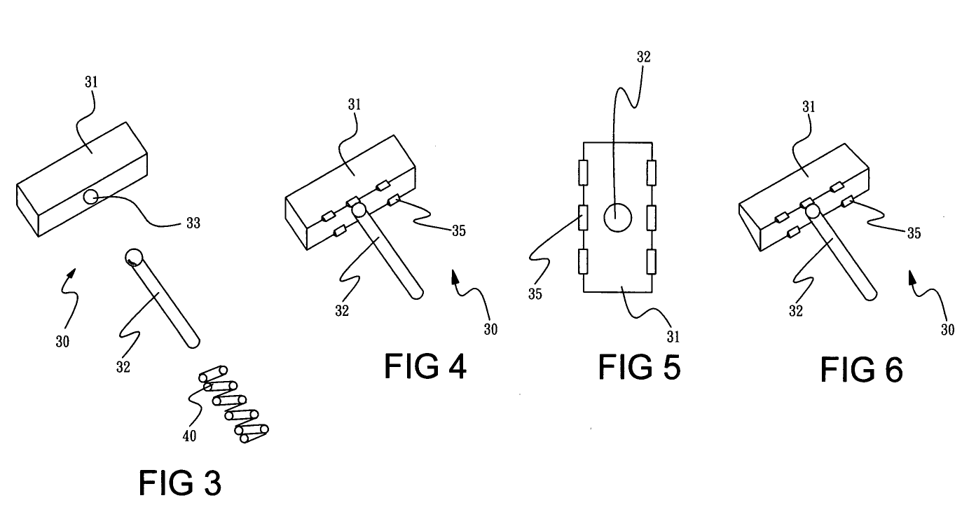

Referring to FIGS. 2 and 3, an articulated joint with a lock device according to the present invention is illustrated. It is noted that identical parts are designated the same reference numbers. In order to overcome the preceding deficiency resided in the conventional lock device, it can be seen in FIGS. 2 and 3, the lock device 30 of the present invention includes a lock block 31 and a fixing pin 32. A side of the lock block 31 provides a locating hole 33 and the fixing pin 32 provides a ball end so as to fit with the locating hole 33 with riveting in way of the lock block 31 being capable of pivotal moving slightly. Hence, the lock block 31 is joined to the locating pin 32 integrally without loosening easily to ensure locking function of the articulated joint and enhance safety of the foldable ladder while in use.

Referring to FIGS. 4 and 5, the lock block 31 is provided with a plurality of projections 35 at two opposite edges of the side joining with the locating pin 32 by means of stamping or the like.

Referring to FIG. 2 again, two ends of the elongated lock block 31 are slidably disposed at and the guide slot 13 at the outer casing shells 11, 12 and are capable of being caught by the locating recesses 231, 232, 233 respectively. When the trigger 50 is stirred, the upper portion of the trigger 50 pushes the lock block 31 downward along the guide slot 13 such that the lock block 31 moves away the original engaged locating recess and the inner casing pair 20 is free from restriction of the lock block 31 to make angular adjustment of the articulated joint possible. The projections 35 perform a function of preventing the lock block 31 from loosening and falling off the guide slot 13 of the respective outer casing shell 11, 12 while the lock block 31 is pushed to move along the guide slot 13 so that steadiness of the articulated joint can be enhanced substantially.

Referring to FIG. 6, another embodiment of the lock device according to the present invention is illustrated. It can be seen that the lock block 31 has two slant opposite lateral sides and it results in a trapezoidal cross section with the side joining with the locating pin 32 being bigger than the opposite side thereof. The trapezoidal shape of the lock block 31 makes the lock block 31 entering the locating recesses 231, 232, 233 more smoothly and rapidly.

It is appreciated that the lock device according to the present invention provides a lock block being joined to the locating pin integrally with a plurality of projections being arranged on the lock block for not only being set up in the articulated joint easily but also overcoming the deficiency of parts of the lock device being loosened apart. Therefore, the lock device of the present invention enhances steadiness itself and avoid danger resulting from the conventional lock device while a foldable ladder with the articulated joint is in operation.

While the invention has been described with reference to the preferred embodiments thereof, it is to be understood that modifications or variations may be easily made without departing from the spirit of this invention, which is defined by the appended claims.

1. An articulated joint for a foldable ladder, comprising:
an outer casing pair, being composed of two opposite outer casing shells being joined to each other, each of the outer casing shells having a first upper circular section and a first lower elongated section with an elongated guide slot disposed at the first upper circular section;
an inner casing pair, being composed of two opposite inner casing shells being joined to each other, each of the inner casing shells having a second upper circular section and a second lower elongated section with three locating recesses provided at the edge of the second upper circular section and a spring seat at the inner side of one of the upper circular section and the second upper circular section being disposed between the first upper circular sections of the two outer casing shells;
a lock device, being composed of an elongated lock block with a locating hole at a side thereof, a locating pin and a spring and two ends of the lock block being able to move in the guide slot of the respective outer casing shells and movably received in one of the locating recesses, an end of the locating pin passing through the spring seat and the spring surrounding the locating pin with an end thereof touching the spring seat; and
a trigger, providing an upper pushing part capable of pressing the lock block apart from one of the locating recesses;
characterized in that the locating pin has an enlarged ball end with a diameter greater than other parts thereof for being joined to the locating hole as a single piece in a way of the lock block being capable of pivotal moving slightly and the lock block provides a plurality of triangular prism shaped projections at two opposite elongated edges of the side fitting with the locating pin for the lock block being unable to move away the guiding slots.

2. (canceled)

3. (canceled)
